(19) United States
(12) Patent Application Publication
(10) Pub. No.: US 2026/0296362 A1
(43) Pub. Date: Oct. 1, 2026

(54) BELT ARRANGEMENT AND VEHICLE SEAT

(71) Applicant: Adient US LLC, Plymouth, MI (US)

(72) Inventors: Markus Joseph SCHMITZ, Wuppertal (DE); Heinrich BEDNER, Langerwehe (DE); Paresh Vilas PATIL, Pune (IN); Felix SOMMERFELD, Aidlingen (DE)

(21) Appl. No.: 19/631,093

(22) Filed: Mar. 27, 2026

(30) Foreign Application Priority Data
Mar. 28, 2025 (DE) 10 2025 112 124.9

(51) Int. Cl. B60R 22/26; B60N 2/64; B60R 22/12; B60R 22/34; B60R 22/18

(52) U.S. Cl. CPC B60R 22/26; B60N 2/64; B60R 22/12; B60R 22/34; B60R 2022/1843

(57) ABSTRACT

A belt arrangement may have a webbing, a belt retractor and a belt exit aperture, through which the webbing is guidable. The belt exit aperture may have a belt exit region and a belt entry region. The belt entry region may be formed as a deflection unit for deflecting a webbing path. The belt exit region may have a larger cross section than the belt entry region. A backrest and a vehicle seat with the backrest and a spacer may utilize the belt arrangement.

### FIELD

The invention relates to a belt arrangement having the features of the preamble of claim 1, and to a backrest having such a belt arrangement and to a vehicle seat with a backrest having such a belt arrangement.

### BACKGROUND

Belt arrangements for buckling up a user of a vehicle seat in a vehicle are generally known. A belt arrangement with a safety belt and a slot-shaped belt deflection element is known from DE 10 2022 002 516 A1.

The invention is based on the object of improving a belt arrangement of the type mentioned at the outset, in particular with regard to variable guiding of the webbing (also referred to as safety belt), and of providing a corresponding backrest and a corresponding vehicle seat.

### SUMMARY

The first object is achieved according to the invention by a belt arrangement having the features of patent claim 1. The second object is achieved according to the invention by a backrest having the features of patent claim 11. The third object is achieved according to the invention by a vehicle seat having the features of patent claim 15. Advantageous design embodiments, which can be used individually or in combination with one another, are the subject matter of the dependent claims.

The belt arrangement according to the invention comprises a webbing (also referred to as safety belt or strap), a belt retractor and a belt exit aperture through which the webbing is guidable, wherein the belt exit aperture comprises an outwardly directed belt exit region and an inwardly directed belt entry region which is formed as a deflection unit for deflecting a webbing path of the webbing. The belt exit region herein can in particular have a larger cross section than the belt entry region. In this way, on the one hand, the belt exit aperture can be optimally adapted to given components, in particular to the vehicle seat, and on the other hand, the belt exit aperture is of a simple and safe construction and design in accordance with the safety specifications, in particular in terms of a head impact-optimized construction. At the same time, such a belt exit aperture with an integrated deflection unit enables reliable, safe and optimal guiding of the webbing, even for users of different sizes of the vehicle seat.

In particular, a belt passage region can be disposed or formed between the belt entry region and the belt exit region.

For optimal and safe, in particular head impact-optimized guiding of the webbing, the webbing can be defined, for example, in the belt entry region by means of the deflection unit and be deflectable or deflected when in contact with the latter.

Additionally, it can be provided that the webbing is guidable, or is guided, without contact and without friction in the belt exit region, and/or is guidable, or is guided, in a defined and low-friction manner in the belt passage region.

For example, the belt passage region, when viewed in the longitudinal section of the belt exit aperture, can open in the shape of a funnel. Additionally, the belt entry region, the belt passage region and the belt exit region, when viewed in the cross section, can in each case be slot-shaped and formed with a varying cross-sectional size.

For example, the belt exit aperture, for example, in the belt entry region, in the belt passage region and/or in the belt exit region, can be externally provided with a support structure. In particular, the belt exit aperture, in particular the belt entry region, the belt passage region and/or the belt exit region, can be externally provided with a rib structure and/or reinforcement. On the inside, the belt exit aperture can be optimized in terms of guiding the webbing, in particular be designed with a sliding surface, in particular a low-friction upper internal layer. In other words: an inner surface of the belt exit aperture can be formed as a sliding surface and/or an outer surface of the belt exit aperture can be provided with the support structure.

In particular, when viewed in section, the belt entry region can comprise an angled or arcuate entry edge. The entry edge can in particular form a belt deflection region and/or a belt support point. This allows the webbing to be easily deflected in its path from the belt retractor in the direction of the belt exit region, or vice versa from the belt exit region in the direction of the belt retractor. In particular, the belt entry region, formed as a deflection unit, can at the same time form a freeing for a threading movement, retraction movement, rolling movement and/or pivoting movement of the webbing in the belt exit aperture.

The belt arrangement can additionally have, for example, a spacer for the belt exit aperture. The spacer can in particular be specified to releasably hold the belt exit aperture in a predefined position. In particular, the spacer and the belt exit aperture are mutually specified and positioned in such a way that the belt entry region forming the deflection unit is disposed outside a head impact zone. As a result, the spacer can be formed to be correspondingly stable and strong, for example, from metal, in order to be able to absorb high forces. By means of the spacer, the belt entry region can form a front deflection point of the belt arrangement. The belt entry region forming the front deflection point is a rear region in relation to the belt exit aperture or an internal region in relation to a backrest. In contrast, the belt exit region forms a front region in relation to the belt exit aperture, or a front and in regions at least an outer region in relation to the backrest.

For example, the belt exit region and the belt entry region can differ in shape and/or dimensions. For example, the belt entry region can be of a slot-shaped design. This reduces or even prevents the webbing from becoming jammed or twisted when it is inserted into the belt exit aperture. In particular, the belt exit region has larger dimensions than the belt entry region. For example, the belt exit region can be substantially formed as a larger slot than the slot of the belt entry region. In particular, the belt exit region can be of the same width or largely identical, and in height be larger than the belt entry region. As a result, the belt exit aperture can be easily used by users of different sizes of the vehicle seat with such a belt arrangement.

For example, the belt exit aperture can be specified in such a way that the webbing exits the belt exit region at different angles of extent relative to the belt deflection region and/or relative to the belt support point, in particular a lower belt deflection region and/or a lower belt support point. For example, the belt exit aperture can be specified for an angle of extent in a range of greater than 0° to 45°. In particular, for this purpose, a lower belt exit region can extend obliquely, in particular at an inclination angle of greater than 0° to 45°, relative to the belt deflection region or the belt support point, and/or relative to an upper belt exit region that extends in a straight line or rectilinearly. In particular, the belt exit aperture has a lower belt deflection point. Such a lower, in particular low, belt deflection point enables a reduction of a resulting load moment acting on the seat structure in the event of belt tensile loading.

Moreover, the belt exit aperture can be specified to support the webbing, in particular in the corresponding belt deflection region and/or in the belt support point. For example, the belt exit aperture in the region of the belt deflection region and/or the belt support point is provided with a corresponding support structure, in particular a rib structure and/or a reinforcement. In this instance, the support structure can be designed in such a way that it is supported on the spacer and/or rests in a supporting manner on the latter.

Additionally, a side, in particular a lower side, of the belt exit aperture can comprise an assembly clearance, for example a continuous slot, for assembling or disassembling the webbing in the belt exit aperture. The assembly clearance, for example a continuous slot, is sized in particular in such a manner that the webbing is insertable, or can be inserted, from the outside substantially vertically into the belt exit aperture and is rotatable, or can be rotated, inside the belt exit aperture to a horizontal use position.

For example, the belt entry region and the belt exit region can be connected to one another. For example, the belt passage region of the belt exit aperture is formed between the belt entry region and the belt exit region. In particular, the belt exit aperture is formed as a three-dimensional, in particular elongate, molded body, in particular as a three-dimensional injection molded body.

Preferably, the belt exit aperture, in particular its belt passage region, can be designed to be funnel-shaped and/or V-shaped in section. For example, an upper belt passage region extends in a straight line, and a lower belt passage region extends obliquely to the upper belt passage region.

The backrest according to the invention comprises the previously described belt arrangement.

The vehicle seat according to the invention comprises the previously described backrest having the previously described belt arrangement. The belt exit aperture can terminate so as to be flush or planar with a front side of the vehicle seat, in particular a front side of the backrest. In particular, below a top edge of the vehicle seat, in particular below an upper side of a backrest, the belt exit aperture is integrated into the latter in such a manner that an angled periphery encircling the belt exit region terminates flush or planar with the front side of the vehicle seat, in particular the front side of the backrest.

As a result, the belt arrangement is integrated into the vehicle seat so as to be optimized for head impact. The belt arrangement is located outside a head impact zone in accordance with ECE-R17 (Economic Commission for Europe, ECE homologation, test procedure for seats and head restraints) and ECE-R21 (provisions for the design of the interior of a vehicle) and is integrated into the backrest.

The backrest comprises at least one attachment point to which a spacer for the belt exit aperture is attached. The attachment point is formed, for example, in an upper backrest region between an outer edge and a head restraint bracket.

In particular, the spacer can project from the backrest perpendicularly, or almost perpendicularly, in particular so as to be directed toward the front, and be fastened to said backrest. By means of such a spacer that projects from the backrest perpendicularly toward the front, or almost perpendicularly toward the front, it can be ensured that the belt entry region formed as a deflection unit, in particular the belt deflection region and/or its belt deflection point, of the belt exit aperture is disposed so as to be offset from the backrest plane toward the front. In other words: The belt deflection region and/or the belt deflection point are/is offset toward the front by means of the spacer and disposed so as to be spaced apart from the backrest.

For example, the spacer can be designed as a U-shaped spacer bracket or as two L-shaped spacer arms. Additionally, the spacer can serve as a support. For this purpose, the spacer can be designed to be sufficiently strong and stable, for example. For example, the spacer can be made from metal. The belt exit aperture can in particular be made from a plastics material.

Additionally, the spacer can have a front receptacle which is specified to releasably hold the belt entry region of the belt exit aperture. In particular, the spacer and the belt exit aperture can have mutually corresponding connecting elements, in particular latching elements, for example latching hooks and latching receptacles, clip-in elements, for example flexible clip-in arms and clip-in receptacles, or the like. At the same time, the spacer for supporting the belt entry region can be designed to correspond in shape, dimension and/or size.

In particular, in an arrangement of a plurality of vehicle seats behind one another, due to the belt exit aperture being integrated on the front side, a head impact of a user of a rear vehicle seat on this front belt exit aperture is reliably avoided. At the same time, the design of the belt exit region with the variable guide region for the webbing allows the vehicle seat to be used for occupants of different sizes. Moreover, the integrated deflection unit allows the webbing to be connected obliquely from the belt retractor to the belt exit aperture. This enables appropriate belt extraction criteria of the belt retractor to be met easily and safely. The belt retractor is disposed in particular within the vehicle seat below the belt exit aperture and offset from the latter for an oblique path of the webbing from the belt retractor to the belt entry region of the belt exit aperture. Preferably, the belt retractor is disposed in a housing which has an upper exit opening for the webbing. In this instance, the belt exit aperture can be releasably fastenable to the upper exit opening, in particular clampable or clipable to the latter.

### DESCRIPTION OF THE FIGURES

The invention is explained in more detail hereunder using advantageous exemplary embodiments illustrated in the figures. However, the invention is not limited to these exemplary embodiments. In the figures:

FIG. 1: shows a vehicle seat with a longitudinal adjustment device in a schematic illustration,

FIG. 2: shows a perspective view of a seat arrangement in a vehicle having a vehicle seat according to the invention with a belt arrangement according to the invention,

FIG. 3: shows a front view of a row of seats with the vehicle seat according to the invention with the belt arrangement according to the invention,

FIG. 4: shows a schematic illustration of a belt arrangement, integrated in an upper area of a backrest of a vehicle seat and with a belt exit aperture integrated flush on a front side of the backrest,

FIG. 5: shows a sectional illustration of the vehicle seat through a belt arrangement of the vehicle seat,

FIG. 6: schematically shows an enlarged perspective view of a backrest from the front, without padding, and in the region of the seat-integrated belt arrangement with belt exit aperture and belt retractor,

FIG. 7: schematically shows an enlarged perspective view of a backrest from the rear, without padding, and in the region of the seat-integrated belt arrangement with belt exit aperture and belt retractor, and

FIG. 8: schematically shows an enlarged top view of the backrest without padding, and of the belt exit aperture.

### DETAILED DESCRIPTION

Corresponding parts are provided with the same reference signs in all figures.

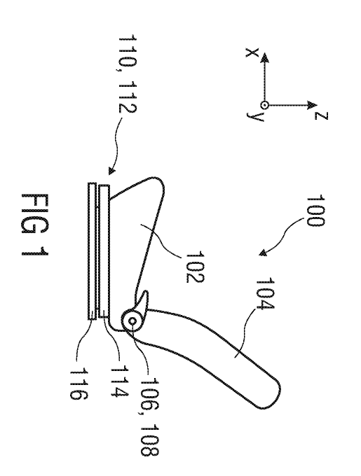

A vehicle seat 100 schematically illustrated in FIG. 1 is described hereunder using three mutually perpendicular spatial directions. A longitudinal direction x extends in a vehicle seat 100 installed in the vehicle largely horizontally and preferably parallel to a vehicle longitudinal direction which corresponds to the normal direction of travel of the vehicle. A transverse direction y extending perpendicularly to the longitudinal direction x is likewise horizontally aligned in the vehicle and extends parallel to a transverse direction of the vehicle. A vertical direction z extends perpendicularly to the longitudinal direction x and perpendicularly to the transverse direction y. In a vehicle seat 100 installed in the vehicle, the vertical direction z preferably extends parallel to a vehicle vertical axis.

The position and direction information used, for example front, rear, top and bottom, refers to a viewing direction of an occupant seated in the vehicle seat 100 in the normal seating position, wherein the vehicle seat 100 installed in the vehicle is oriented in a use position suitable for passenger transport with an upright backrest 104 and as usual in the direction of travel. However, the vehicle seat 100 can also be installed or moved in a different orientation, for example transversely to the direction of travel. Unless otherwise described, the vehicle seat 100 is constructed mirror symmetrically to a plane extending perpendicularly to the transverse direction y.

The backrest 104 can be disposed pivotably on a seat part 102 of the vehicle seat 100. For this purpose, the vehicle seat 100 can optionally comprise a fitting 106, in particular an adjusting fitting, rotating fitting, latching fitting or tumbling fitting.

The position and direction information used, such as radial, axial and circumferential, refers to a rotation axis 108 of the fitting 106. Radial means perpendicular to the rotation axis 108. Axial means in the direction of or parallel to the rotation axis 108.

The vehicle seat 100 can optionally comprise a longitudinal adjustment device 110. The longitudinal adjustment device 110 comprises, for example, a rail assembly 112 having a first rail element 114 and a second rail element 116. The first rail element 114 is adjustable in the longitudinal direction x relative to the second rail element 116. The first rail element 114 is fastened to the seat part 102. The second rail element 116 is fastened to a structural element of a vehicle, for example, a vehicle floor.

For better clarity, the first rail element 114 is referred to as upper rail 114 in the following description. This upper rail 114 (also called running rail or slide) is assigned to the vehicle seat 100 and is specified to support this vehicle seat 100. The second rail element 116 is referred to as lower rail 116 hereunder. The lower rail 116 is fixed and connected, for example, to the floor of a vehicle.

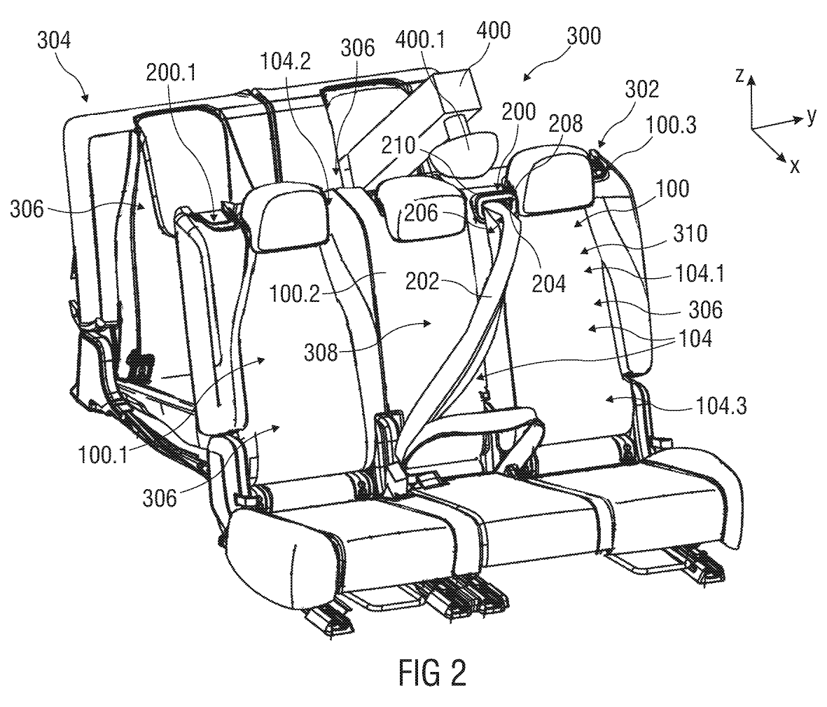

The vehicle seat 100 can comprise a belt arrangement 200 according to the invention, as described below with reference to FIGS. 2 to 8.

FIG. 2 shows a perspective view of a seat arrangement 300 in a vehicle having the vehicle seat 100 according to the invention with the belt arrangement 200 according to the invention.

For example, the seat arrangement 300 comprises a front row of seats 302 and a rear row of seats 304.

The rear row of seats 304, for example, has a so-called 60-60 seat split with two wide seat faces 306. Alternatively, the rear row of seats 304 can also have a 60-40 seat split or a 40-20-40 seat split. The front row of seats 302, for example, has a so-called 60-40-60 seat split with two wide seat faces 306 and a central narrow seat face 308. Thus, for example, a backrest face 310 can be folded in a ratio of 60 to 40. Due to this split, a part of the backrest face 310, in particular one of the backrests 104 of the wide seat face 306 or the narrow seat face 308, can be folded, while the other remains available as a seat. Alternatively, the front row of seats 302 can have a 50-50 seat split or a 60-40 seat split.

The right-hand vehicle seat 100 of the front row of seats 302 has the inventive belt arrangement 200. The left-hand vehicle seat 100.1 of the front row of seats 302 has a conventional belt arrangement 200.1.

The belt arrangement 200 is designed as a seat-integrated belt arrangement 200 according to the invention. The belt arrangement 200 comprises a webbing 202 (also referred to as safety belt), by means of which a user of the central vehicle seat 100.2 can be buckled and secured. The belt arrangement 200 comprises a belt exit aperture 204 for guiding and for exiting the webbing 202, which is disposed flush or planar on a front side 104.1 of the backrest 104.

The left-hand vehicle seat 100.1 has a conventional belt arrangement 200.1, which is integrated on an upper side 104.2 of the backrest 104 so as to be flush with the latter.

As opposed to the conventional belt arrangement 200.1, the belt arrangement 200 according to the invention is head impact-optimized. In particular in an accident, an occupant 400 (represented as a dummy) of the rear row of seats 304 may impact the upper side 104.2 of the backrest 104 of the front row of seats 302 with their head 400.1 (illustrated as a ball). Due to the arrangement of the belt arrangement 200 according to the invention on the front side 104.1 of the backrest 104, the head 400.1 impacts on a padding 104.3 of the vehicle seat 100 and not on the forward-facing belt exit aperture 204 of the belt arrangement 200. This significantly reduces the risk of injury. In addition to the arrangement integrated in the front side of the backrest 104, the belt exit aperture 204 can be specified, for example, in such a way that the webbing 202 exits an in particular front belt exit region 208 at different angles of extent 206.

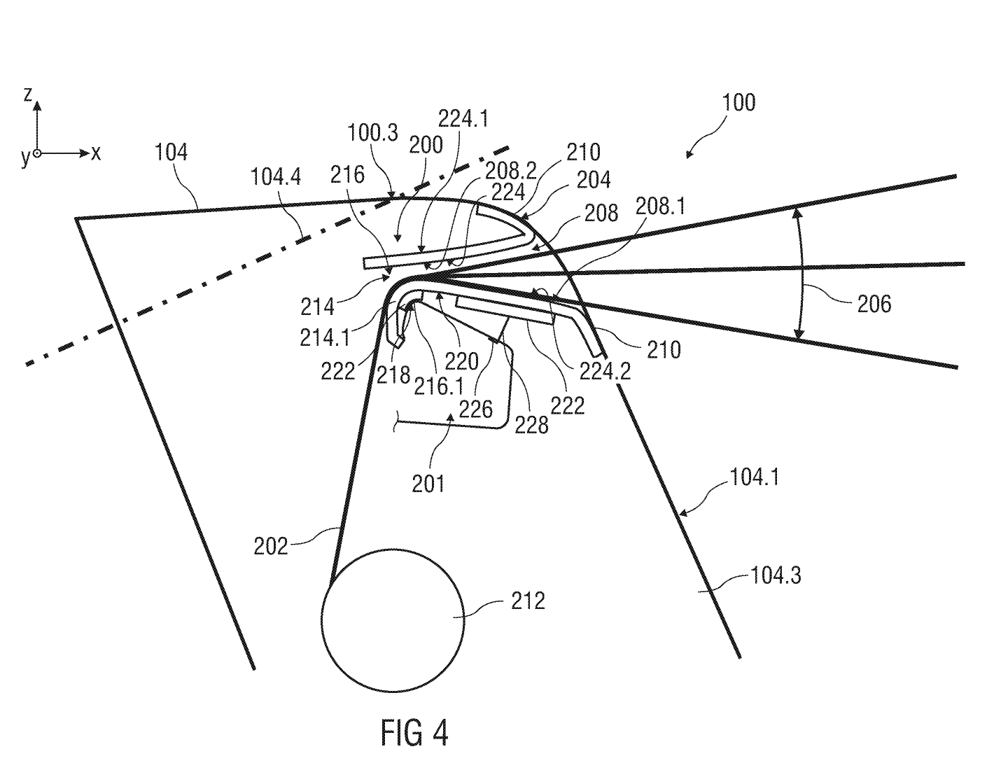

For this purpose, the in particular front belt exit region 208 can have a larger cross section than an in particular rear belt entry region 214 (illustrated in FIG. 4). The belt exit region 208 is understood to be, in particular, the forward-facing or outwardly directed region of the belt exit aperture 204, from which the webbing 202 exits for application and can be gripped, for example. The belt entry region 214 is understood to be, in particular, that region of the belt exit aperture 204 through which the webbing 202 is introduced, for example, from a belt retractor 212 (illustrated in FIG. 4) into the belt exit aperture 204.

In this instance, the webbing 202 can be guidable, or can be guided, in particular in a defined manner, with low friction in a belt passage region 224 (illustrated in FIG. 4) provided and/or formed between the belt entry region 214 and the belt exit region 208. For example, the belt passage region 224, when viewed in the longitudinal section of the belt exit aperture 204, can open in the shape of a funnel.

Additionally, the belt entry region 214, the belt passage region 224 and the belt exit region 208, when viewed in cross section, can in each case be slot-shaped and designed with varying cross-sectional size, as illustrated in FIG. 4.

For example, the belt exit aperture 204 can be specified for an angle of extent 206 in a range of greater than 0° to 45°.

In summary, due to its arrangement integrated on the front side 104.1, the belt arrangement 200 is integrated into the vehicle seat 100 so as to be optimized for head impact, and in addition by virtue of a variable belt exit region 208 with different angles of extent 206 is usable by users of different sizes of the vehicle seat 100. In particular, in an arrangement of a plurality of vehicle seats 100 behind one another, due to the belt exit aperture 204 being integrated on the front side 104.1, an impact of the head 400.1 is reliably avoided.

The belt exit aperture 204 according to the invention terminates in particular so as to be flush or planar with the front side 104.1 of the vehicle seat 100, in particular of the backrest 104. Below an upper edge 100.3 of the vehicle seat 100, in particular below the upper side 104.2 of the backrest 104, the belt exit aperture 204 is in particular integrated into this backrest 104 in such a manner that an angled periphery 210 encircling the belt exit region 208 terminates so as to be flush or planar with the front side 104.1 of the backrest 104.

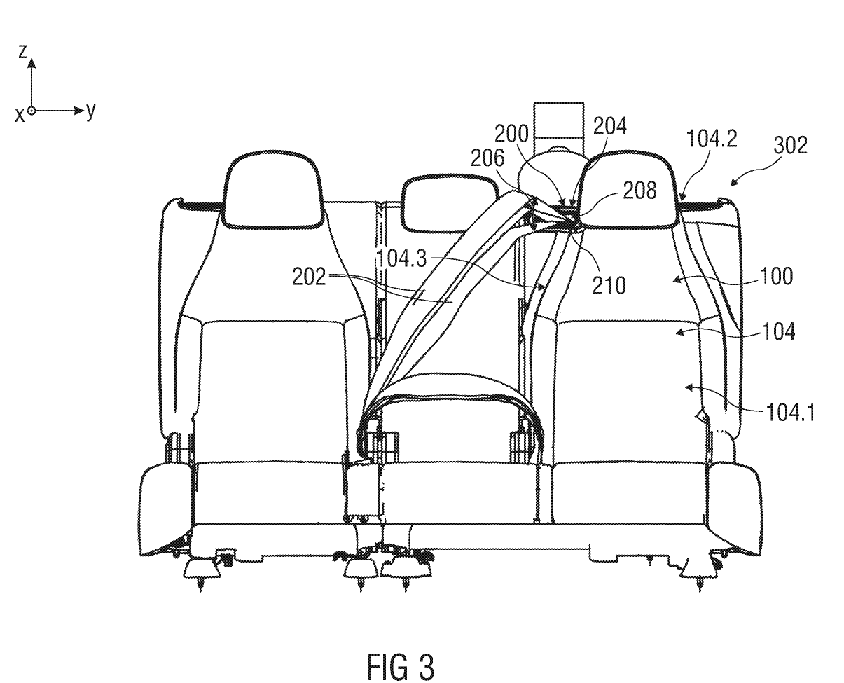

FIG. 3 shows a top view of the front row of seats 302 having the vehicle seat 100 according to the invention with the belt arrangement 200 according to the invention.

The webbing 202 exits the belt exit region 208 of the belt exit aperture 204 at a variable angle of extent 206.

The periphery 210 terminates in particular so as to be flush or planar with the front side 104.1 of the backrest 104. Below the upper side 104.2 of the backrest 104, the belt exit aperture 204 is integrated into this backrest 104 on the front side 104.1 of the latter, in particular into the padding 104.3, in such a manner that the encircling periphery 210 of the belt exit region 208 terminates so as to be flush or planar with the front side 104.1.

FIG. 4 shows a schematic illustration of the belt arrangement 200, integrated into the upper region of the backrest 104 and with the belt exit aperture 204 integrated flush on the front side 104.1 of the backrest 104.

The belt arrangement 200 is integrated into the backrest 104 below an impact zone 104.4.

The belt arrangement 200 can additionally have, for example, a spacer 201 for the belt exit aperture 204. The spacer 201 can in particular be specified to hold the belt exit aperture 204 in a predefined, in particular in a front and lower, position which is outside the impact zone 104.4.

The belt arrangement 200 comprises a belt retractor 212 and the belt exit aperture 204 through which the webbing 202 is guidable, the latter being windable onto/unwindable from the belt retractor 212.

The belt exit aperture 204 comprises a belt exit region 208 and a belt entry region 214. The belt entry region 214 is designed as a deflection unit 216 for deflecting a webbing path of the webbing 202.

In particular, the spacer 201 and the belt exit aperture 204 are mutually specified and positioned in such a manner that the belt entry region 214 forming the deflection unit 216 is disposed outside the impact zone 104.4, in particular a head impact zone. As a result, the spacer 201 can be formed to be correspondingly stable and strong, for example, from metal, in order to be able to absorb high forces.

By means of the spacer 201, the belt entry region 214 can form a front deflection point 216.1 of the belt arrangement 200. Additionally, the belt entry region 214 forms a lower deflection point 216.1. Due to the deflection point 216.1 being formed as a lower deflection point 216.1, the moment acting on the backrest 104 can be reduced in the event of belt tensile loading.

The belt entry region 214 forming the front, lower deflection point 216.1 is a rear region in relation to the belt exit aperture 204, or an internal front region in relation to a backrest 104. In contrast, the belt exit region 208 forms a front region in relation to the belt exit aperture 204, or a front and in regions at least an outer region in relation to the backrest 104.

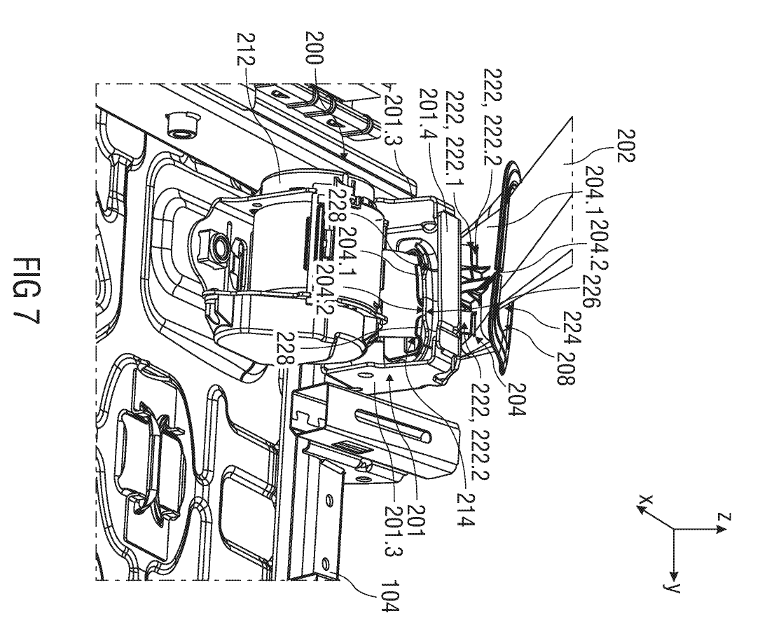

The spacer 201 can additionally be specified to releasably hold the belt exit aperture 204, as shown in detail in FIG. 7. In addition to the arrangement integrated into the front side of the backrest 104, the belt exit aperture 204 can, for example, be specified in such a way that the webbing 202 exits the belt exit region 208 at different angles of extent 206 relative to a belt deflection region 218 and/or relative to a belt support point 220, in particular a lower belt deflection region 218 and/or a lower belt support point 220. For example, the belt exit aperture 204 can be specified for an angle of extent 206 in a range of greater than 0° to 45°. In particular, such a range of the angle of extent 206 for the exiting webbing 202 is specified by means of shape and/or dimensions of the belt exit aperture 204 that occupants 400 of different body sizes, in particular tested using so-called dummy sizes from 5% to 95%, are covered.

Thus, the belt exit aperture 204 is on the one hand optimally adapted to given components, in particular to the vehicle seat 100. On the other hand, this renders the design of the belt exit aperture 204 simple and safe in accordance with safety specifications, in particular with regard to a head impact-optimized construction in accordance with ECE-R17 and ECE-R21. In particular, such a belt exit aperture 204 with an integrated deflection unit 216 enables reliable and safe as well as optimal guiding of the webbing 202, even with different-sized users of the vehicle seat 100. The belt arrangement 200 moreover has fewer components and is easy to assemble or disassemble.

Additionally, the belt exit aperture 204 in the belt entry region 214 and/or in the belt exit region 208 can be provided externally with a support structure 222.

In particular, the belt entry region 214, when viewed in section, can comprise an angled or arcuate entry edge 214.1. As a result, the webbing 202 can be easily deflected in its course from the belt retractor 212 in the direction of the belt exit region 208, or vice versa from the belt exit region 208 in the direction of the belt retractor 212.

For example, the belt exit region 208 and the belt entry region 214 can differ in shape and/or dimensions. For example, the belt entry region 214 can be slot-shaped. This reduces or even avoids jamming or twisting of the webbing 202 when it is inserted into the belt exit aperture 204.

The belt exit region 208 has in particular larger dimensions than the belt entry region 214.

For example, the belt exit aperture 204 can be specified in such a way that the webbing 202 exits the belt exit region 208 at different angles of extent 206 relative to the belt deflection region 218 and/or relative to the belt support point 220. In particular, for this purpose, a lower belt exit region 208.1 can extend obliquely, in particular at an inclination angle of greater than 0° to 45°, relative to the belt deflection region 218 and/or the belt support point 220, and/or relative to an upper belt exit region 208.2 that extends in a straight line or rectilinearly.

The belt deflection region 218 and/or the belt support point 220 are in particular specified or disposed on the belt exit aperture 204 in such a way that a lower, in particular low, belt deflection point is formed, which reduces a load moment acting on the seat structure in the event of belt tensile loading.

For example, the belt entry region 214 and the belt exit region 208 can be connected to one another and form a belt passage region 224 of the belt exit aperture 204.

In particular, the belt exit aperture 204 is formed as a three-dimensional molded body, in particular as a three-dimensional plastic molded body, for example an injection-molded body.

Preferably, the belt passage region 224 can be funnel-shaped and/or V-shaped in section. For example, an upper belt passage region 224.1 extends in a straight line and a lower belt passage region 224.2 extends obliquely to the upper belt passage region 224.1.

Below the upper edge 100.3 of the vehicle seat 100, the belt exit aperture 204 is integrated into the latter in such a manner that the angled periphery 210 encircling the belt exit region 208 terminates so as to be flush or planar with the front side 104.1 of the vehicle seat 100, in particular the backrest 104 of the latter.

The belt retractor 212 is integrated below the belt exit aperture 204 and obliquely offset therefrom in the vehicle seat 100, in particular in the padding 104.3.

Due to the deflection unit 216 integrated into the belt exit aperture 204 and the offset arrangement of the belt retractor 212 and the belt exit aperture 204, the webbing 202 extends from the belt retractor 212 into the belt exit aperture 204 obliquely, in particular at a predefined inclination angle. This enables appropriate belt extraction criteria of the belt retractor 212 to be fulfilled easily and safely.

In other words: The belt retractor 212 is disposed within the vehicle seat 100 below the belt exit aperture 204 and offset therefrom for an oblique path of the webbing 202 from the belt retractor 212 to the belt entry region 214 of the belt exit aperture 204.

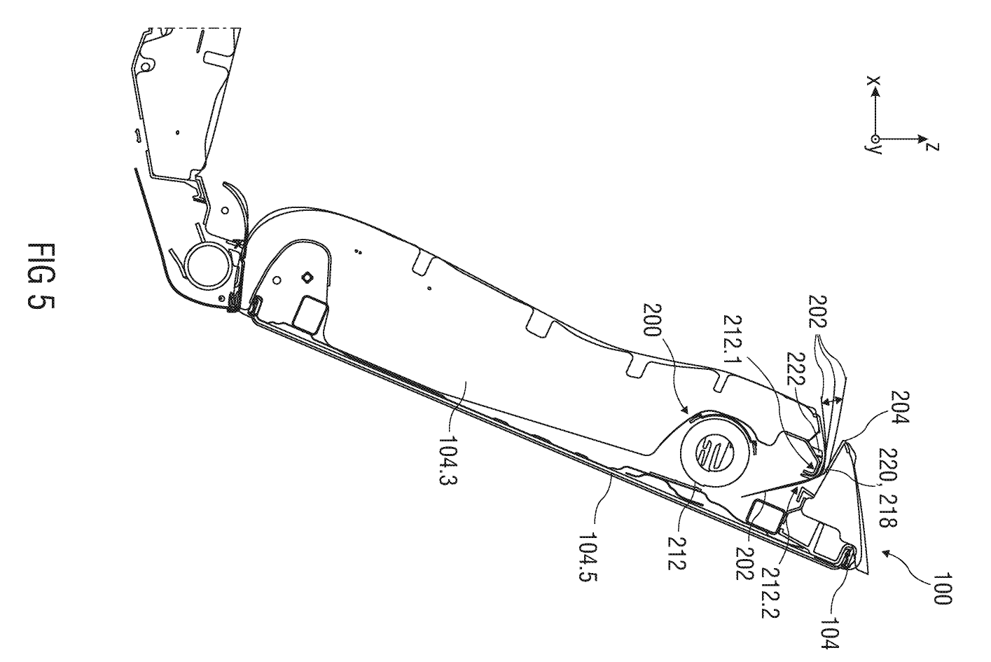

FIG. 5 shows a sectional illustration of the vehicle seat 100 through the belt arrangement 200.

The belt retractor 212 is disposed, for example, in a housing 212.1. The belt retractor 212 is disposed and fastened via the housing 212.1 to a seat structure 104.5, in particular a seat support, for example a seat frame or a seat shell.

To support and to dissipate forces acting thereon, the belt exit aperture 204 can be provided with the support structure 222 (also called the stiffening structure or support structure). The support structure 222 is disposed in particular in the belt deflection region 218 and/or in the belt support point 220 of the webbing 202, on an outside of the belt exit aperture 204, in order to support/lend support to the latter.

The housing 212.1 has an upper exit opening 212.2 for the webbing 202. In this instance, the belt exit aperture 204 can be releasably fastenable to the upper exit opening 212.2, in particular clampable or clipable to the latter.

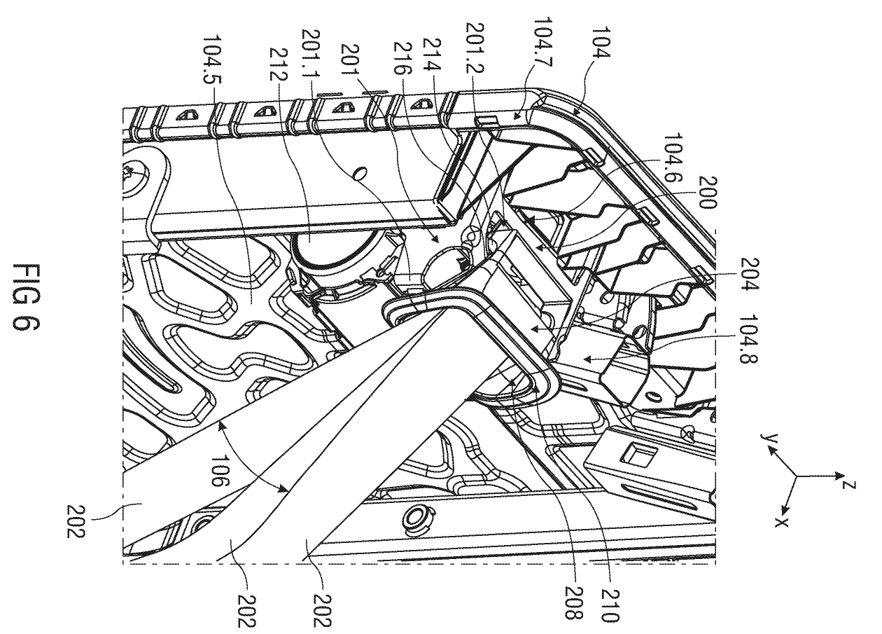

FIG. 6 schematically shows an enlarged perspective view of the backrest 104, in particular its seat structure 104.5, for example a shell structure, from the front without padding 104.3 (illustrated in FIG. 5) and in the region of the seat-integrated belt arrangement 200 with the belt exit aperture 204 and the belt retractor 212 for the variably extending webbing 202 with the different angles of extent 206.

The belt exit aperture 204 is formed as a three-dimensional molded body. The belt exit aperture 204 can be L-shaped. The belt exit region 208 with the terminating periphery 210 projects perpendicularly from the seat structure 104.5 in such a manner that the periphery 210 rests in a planar or flush manner on the front side 104.1 of the padding 104.3 shown in FIG. 5.

The belt entry region 214 (also illustrated in FIG. 4) can be angled downward in the direction of the belt retractor 212.

The belt exit aperture 204 can be formed as a hollow body and be partially open.

The backrest 104 comprises at least one attachment point 104.6 to which the spacer 201 for the belt exit aperture 204 is attached. The attachment point 104.6 is formed, for example, in an upper backrest region between an outer edge 104.7 and a head restraint bracket 104.8.

For example, the spacer 201 can project vertically or almost vertically from the backrest 104, in particular so as to be directed forward, and can be fastened to the latter at the rear, in particular to a frame or a shell. By means of such a spacer 201 projecting from the backrest 104 vertically forward or almost vertically forward, it can be ensured that the belt entry region 214 formed as the deflection unit 216 (illustrated in FIG. 4), in particular its belt deflection region 218 and/or its belt support point 220, of the belt exit aperture 204 is disposed so as to be offset toward the front from the backrest plane. In other words: The belt deflection region 218 and/or the belt support point 220 are/is offset toward the front by means of the spacer 201 and disposed so as to be spaced apart from the backrest 104.

For example, the spacer 201 can be formed as a U-shaped spacer bracket 201.1. Additionally, the spacer 201 can serve as a support. For this purpose, the spacer 201 can be designed, for example, to be sufficiently strong and stable. For example, the spacer 201 can be made from metal. The belt exit aperture 204 can in particular be made from a plastics material.

Additionally, the spacer 201 can have a front receptacle 201.2, which is specified to releasably hold the belt entry region 214 of the belt exit aperture 204.

FIG. 7 schematically shows an enlarged perspective view of the backrest 104 from the rear without padding 104.3 (illustrated in FIG. 5) and in the region of the seat-integrated belt arrangement 200 with the belt exit aperture 204 and the belt retractor 212 for the webbing 202.

Alternatively, the spacer 201 can be formed as two L-shaped spacer arms 201.3. These spacer arms 201.3 can optionally be connected via a web 201.4.

In particular, the spacer 201 and the belt exit aperture 204 can have mutually corresponding connecting elements 226, 228, in particular latching elements, for example, latching hooks and latching receptacles, clip-in elements, for example flexible clip-in arms and clip-in receptacles, or the like. In particular, the belt entry region 214 and/or the belt exit region 208 can as a support structure 222 be provided externally with a rib structure 222.1 and/or reinforcements 222.2. At the same time, the spacer 201 for supporting the belt entry region 214 can be correspondingly designed in shape, dimension and/or size. In particular, the spacer 201 can in regions be wedge-shaped or oblique. In this instance, the rib structure 222.1 and/or reinforcements 222.2 can be supported on the outer support region of the spacer 201, or rest thereon.

On the inside, the belt exit aperture 204 can be optimized with regard to guiding the webbing 202, in particular be designed with a sliding surface, in particular a friction-free upper inner layer. In other words: An inner surface of the belt exit aperture 204 can be formed as a sliding surface and/or an outer surface of the belt exit aperture 204 can be provided with the support structure 222.

Additionally, a side 204.1, in particular a lower side, of the belt exit aperture 204 can comprise a continuous assembly clearance 204.2, in particular a slot, for assembling or disassembling the webbing 202 in the belt exit aperture 204. The assembly clearance 204.2 is designed in particular as a continuous slot and in particular sized in such a manner that the webbing 202 is insertable, or can be inserted, from the outside substantially vertically into the belt exit aperture 204 and is rotatable, or can be rotated, to a horizontal use position inside the belt exit aperture 204, in particular in the belt entry region 214, the belt passage region 224 and the belt exit region 208.

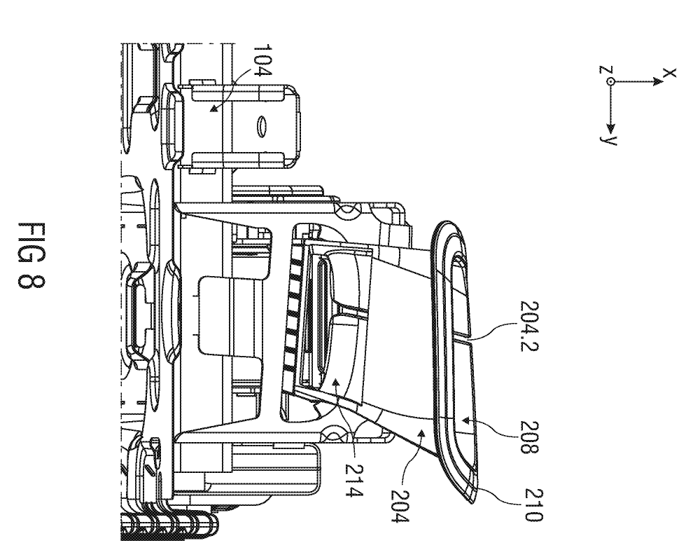

FIG. 8 schematically shows an enlarged top view of the backrest 104 without the padding 104.3, without the webbing 202 (illustrated in FIG. 5) and of the belt exit aperture 204, integrated into the backrest 104, with the encircling periphery 210 of the outwardly directed belt exit region 208, with the continuous assembly clearance 204.2 and the inwardly directed belt entry region 214, the latter being designed to be smaller than the belt exit region 208.

### LIST OF REFERENCE SIGNS

100 Vehicle seat, right-hand vehicle seat

100.1 Left-hand vehicle seat

100.2 Center vehicle seat

100.3 Top edge

102 Seat part

104 Backrest

104.1 Front side

104.2 Upper side

104.3 Padding

104.4 Impact zone

104.5 Seat structure

104.6 Attachment point

104.7 Outer edge

104.8 Head restraint bracket

106 Fitting

108 Rotation axis

110 Longitudinal adjustment device

112 Rail assembly

114 First rail element (upper rail)

116 Second rail element (lower rail)

200 Belt arrangement

200.1 Conventional belt arrangement

201 Spacer

201.1 U-shaped spacing bracket

201.2 Receptacle

201.3 Spacer arm

201.4 Web

202 Webbing

204 Belt exit aperture

204.1 Side

204.2 Assembly clearance

206 Angle of extent

208 Belt exit region

208.1 Lower belt exit region

208.2 Upper belt exit region

210 Periphery

212 Belt retractor

212.1 Housing

212.2 Exit opening

214 Belt entry region

214.1 Entry edge

216 Deflection unit

216.1 Deflection point

218 Belt deflection region

220 Belt support point

222 Support structure

222.1 Rib structure

222.2 Reinforcement

224 Belt passage region

224.1 Upper belt passage region

224.2 Lower belt passage region

226, 228 Corresponding connecting elements

300 Seat arrangement

302 Front row of seats

304 Rear row of seats

306 Wide seat face

308 Narrow seat face

310 Backrest face

400 Occupant

400.1 Head

x Longitudinal direction

y Transverse direction

z Vertical direction

1. A belt arrangement having a webbing, a belt retractor and a belt exit aperture through which the webbing is guidable,
wherein the belt exit aperture comprises a belt exit region and a belt entry region,
wherein the belt entry region is formed as a deflection unit for deflecting a webbing path of the webbing,
wherein the belt exit region has a larger cross section than the belt entry region.

2. The belt arrangement as claimed in claim 1,
wherein the webbing is guidable, or is guided, with low friction in a belt passage region provided between the belt entry region and the belt exit region.

3. The belt arrangement as claimed in claim 2,
wherein the belt passage region, when viewed in a longitudinal section of the belt exit aperture, opens in the shape of a funnel.

4. The belt arrangement as claimed in claim 2,
wherein the belt entry region, the belt passage region and the belt exit region, when viewed in a cross section, are in each case slot-shaped and formed with a varying cross-sectional size.

5. The belt arrangement as claimed in claim 1,
wherein the belt exit aperture is externally provided with a support structure.

6. The belt arrangement as claimed in claim 1,
wherein the belt entry region, when viewed in section, comprises an angled or arcuate entry edge which forms a belt deflection region and/or a belt support point.

7. The belt arrangement as claimed in claim 1,
comprising a spacer which is specified to releasably hold the belt exit aperture.

8. The belt arrangement as claimed in claim 6,
wherein the belt exit aperture is specified in such a way that the webbing exits the belt exit region at different angles of extent relative to the belt deflection region and/or relative to the belt support point.

9. The belt arrangement as claimed in claim 6,
wherein the belt exit aperture is specified to support the webbing in the corresponding belt deflection region and/or in the belt support point.

10. The belt arrangement as claimed in claim 1,
wherein one side of the belt exit aperture comprises an assembly clearance for assembling or disassembling the webbing.

11. A backrest having the belt arrangement as claimed in claim 1.

12. The backrest as claimed in claim 11,
comprising an attachment point to which a spacer is attached.

13. The backrest as claimed in claim 12,
wherein the spacer is fastened to the backrest so as to project perpendicularly from the latter, and is designed as a U-shaped spacer bracket or as two L-shaped spacer arms.

14. The backrest as claimed in claim 12,
wherein the spacer has a front receptacle which is specified to releasably hold the belt entry region of the belt exit aperture.

15. A vehicle seat comprising a backrest as claimed in claim 11.
